(19) United States
(12) Patent Application Publication
(10) Pub. No.: US 2012/0239279 A1
(43) Pub. Date: Sep. 20, 2012

(54) FUEL CONTROL MODULE MAPPING SYSTEM, METHOD AND APPARATUS FOR BI-FUEL AND DUAL FUEL VEHICLES

(76) Inventors: Aaron Stuart, Layton, UT (US); Chad Buttars, Ogden, UT (US)

(21) Appl. No.: 13/048,718

(22) Filed: Mar. 15, 2011

(51) Int. Cl. F02D 29/00

(52) U.S. Cl. 701/107

(57) ABSTRACT

An apparatus, system and method are disclosed for forcing the fuel control module of a converted bi-fuel vehicle to reference a substitute fuel control map. The apparatus comprises a box affixed inside the cabin of a bi-fuel vehicle to the OBD port which sends false signals to the fuel control module indicating that the bi-fuel vehicle is running on a gasoline, ethanol, or a fuel other than the fuel powering the internal combustion engine. In some embodiments, the box in communication with the fuel control module feeds false sensor readings to the fuel control module to optimize fuel control in the vehicle engine. In other embodiments, the box overrides OEM sensor relay information, or forces the fuel control module to reference aftermarket sensors installed in place of, or in addition to, the OEM sensors.

### BACKGROUND OF THE INVENTION

1. Field of the Invention

This invention relates to fuel control modules, and more particularly relates to fuel tables used by bi-fuel vehicle control modules to regulate fuel combustion engines.

2. Description of the Related Art

Fuel Control Modules (FCMs) are a type of computer assisted, electronic control unit in vehicles powered by internal combustion engines. FCMs determine the amount of fuel needed to optimally run an internal combustion engine. FCMs regulate fuel flow, timing, and other performance controls. FCM realize these functions by, inter alia, reading metrics from multidimensional performance “maps” (i.e. look up table data structures) stored in computer readable memory, using input values like engine speed, altitude, temperature, humidity, and the like, calculated from signals emanating from sensor devices monitoring the engine and/or the exhaust. Before FCM's, air/fuel mixture, ignition timing, and idle speed were directly controlled by mechanical and pneumatic sensors and actuators.

Standard OEM vehicles configured to run on unleaded gasoline are designed only to alternatively reference maps optimized for gasoline and ethanol. Standard OEM vehicles do not comprise equipment, sensors or maps needed to run alternative fuels such a propane and natural gas. When standard OEM vehicles are retrofitted to run wholly or in part on alternative fuels, such as natural gas (CNG), hydrogen, LPG, diesel and methane, or the like, the converted vehicles lack not just the necessary maps, but also the ability to even recognize the need to reference an alternative map associated with the alternative fuel. When the original gasoline maps are replaced with newer maps for alternative fuel, the vehicle loses the ability to reference the old gasoline map as continues to be necessary on bi-fuel, or dual fuel, vehicles. The maps cannot be rotatably interchanged with secondary maps as is necessary in vehicles running on multiple fuel types. Additionally, maps have are not regularly available for natural gas or propane.

Converted bi-fuel vehicles store separate fuels in separate fuel tanks inside the vehicle, and the maps in converted vehicles are specific to the specific type of single fuel upon which the vehicle formerly ran. These converted vehicles lack the ability to switch back-and-forth between maps associated with the differing fuel types in the bi-fuel vehicle.

In some embodiments, the vehicle is configured to automatically switch between the two fuels when one fuel reaches a state of depletion. In most embodiments, the vehicle runs on one fuel at a time, but flexible-fuel vehicles (“dual-fuel”) are also known in the art, which comprise engines configured to run on different fuels mixed together in the same tank. Bi-fuel vehicles cannot switch between maps fuel sources are switched.

As bi-fuel vehicles become more engrained in mainstream society, mapping technologies for bi-fuel vehicles must necessarily evolve also.

### SUMMARY OF THE INVENTION

From the foregoing discussion, it should be apparent that a need exists for an apparatus, system and method for configuring a converted bi-fuel vehicle to a map optimized for the alternative fuel powering its internal combustion engine. The present invention has been developed in response to the present state of the art; and, in particular, in response to the problems and needs in the art that have not yet been fully solved by currently available methods, systems and apparatii, and that overcomes many or all of the above-discussed shortcomings in the art. Accordingly, the present invention has been developed to provide a fuel control mapping system, method and apparatus for bi-fuel vehicles.

A method is disclosed for overriding sensory input to an OEM fuel control module in a vehicle such that the fuel control module of the vehicle optimally regulates fuel flow of an alternative fuel to an internal combustion engine, the steps of the method comprising: reprogramming a look up table data structure in persistent computer readable memory accessible by the fuel control module (the “ethanol map”) such that the ethanol map comprises values optimized for regulating performance of the internal combustion engine on the alternative fuel, wherein the alternative fuel comprises one of propane, hydrogen, and natural gas; wherein the map, before reprogramming, is exclusively referenced by the fuel control module when the vehicle is sensed by the fuel control module to be running on ethanol.

The method further comprises affixing an aftermarket control unit to a signal bearing medium for carrying an electronic signal from an ethanol sensor measuring fuel in the vehicle's fuel line; wherein the fuel control module was originally configured to regulate fuel flow of one or more of gasoline and ethanol; manually activating a switching mechanism on the control unit; and relaying a digital signal via the control unit, in response to activation of the switching mechanism, to the fuel control module falsely indicating one of: the presence of ethanol in a fuel line, and that the vehicle is running on ethanol.

The method further comprises forcing the fuel control module to reference the ethanol map in internal persistent computer readable memory; forcing the fuel control module to regulate fuel flow of the alternative fuel to the internal combustion engine in accordance with the reprogrammed ethanol map; and running the internal combustion engine on the alternative fuel.

The method may further comprise one or more of the steps of: installing aftermarket fuel injectors on the vehicle for injecting the alternative fuel; temporarily disabling OEM sensors on OEM fuel injectors in response to the button on the control unit being depressed; and relaying electronic signals on aftermarket sensors affixed to the aftermarket fuel injectors to the fuel control unit in place of electronic signals from the OEM fuel injectors.

The method may also comprise one or more of the steps of: installing aftermarket one or more aftermarket fuel rails on the vehicle, the fuel rail comprising one or more of a fuel pressure sensor and a fuel temperature sensor; temporarily disabling one or more OEM fuel pressure sensors in response to the button on the control unit being depressed; temporarily disabling one or more OEM fuel temperature sensor(s) in response to the button on the control unit being depressed; and relaying electronic signals from sensors on the fuel rail to the fuel control unit in place of electronic signals from the OEM fuel injectors.

A control unit for overriding an ethanol sensor in a vehicle is also disclosed, the control unit comprising: a housing between 0.1 liters and 2 liters in volume; one or more signal bearing wires for logically communicating a digital signal to a fuel control module of a vehicle, the wires configured to bypass an ethanol fuel sensor sensing ethanol passing through a fuel line of the vehicle; a button affixed to outside of the housing; and an electronic signal relay module, housed within the housing, for relaying a digital signal to the fuel control module via the signal bearing medium used by the ethanol sensor, the digital signal overriding the ethanol sensor in response to the button on the housing being depressed, wherein the digital signal falsely indicates to the fuel control module that ethanol is being run through the fuel line.

The control unit may be in communication with the fuel control module of the vehicle, wherein the control unit is configured to replace digital readings received by the fuel control module from OEM sensors on fuel injectors, and wherein the control unit is further configured to replace said digital readings with substitute digital readings derived from one of: aftermarket sensors on one of the fuel line and the fuel injectors, and readings stored in one or more computer readable database tables in computer readable memory within the housing.

The control unit may also further comprise one or more LED(s) configured to activate on when the button is depressed.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a flow chart of a method of method for overriding sensory input to an OEM fuel control module in accordance with the present invention; and

FIG. 2 is a block diagram illustrating another embodiment of control unit for overriding an ethanol sensor in a vehicle in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus. The teachings of the present invention apply to dual-fuel vehicles as they do to bi-fuel vehicles.

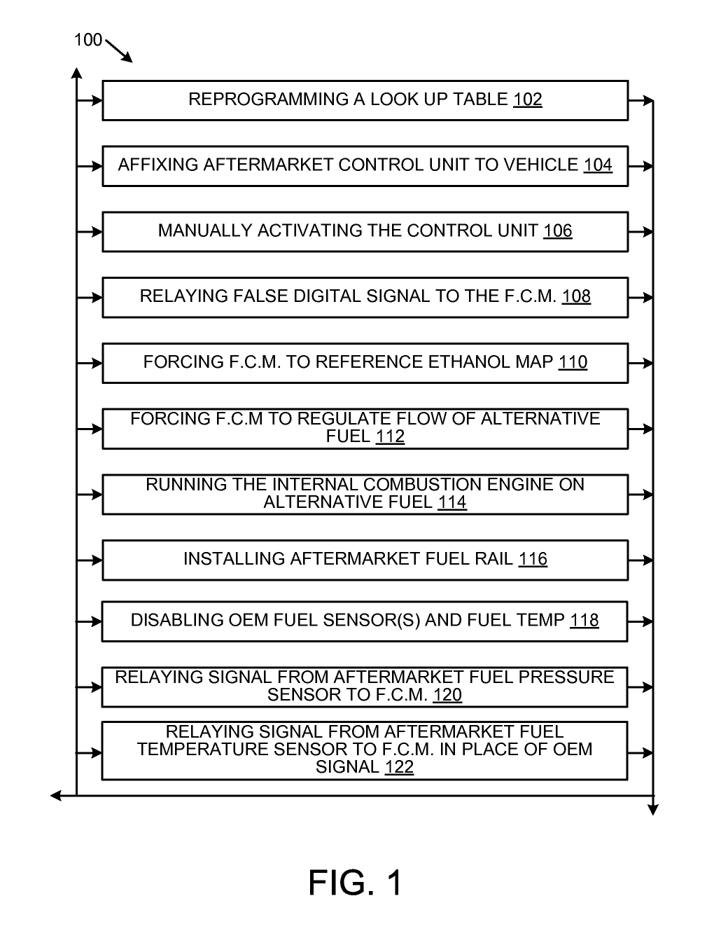

FIG. 1 is a flow chart of a method 100 of method for overriding sensory input to an OEM fuel control module in accordance with the present invention.

The method 100 begins with reprogramming 102 a look up table data structure in persistent computer readable memory accessible by the fuel control module (the “ethanol map”). This may be accomplished using means known to those of skill in the art, or by logically connecting the control unit 200 to the OBDII port of the vehicle and using the control unit 200 to reprogram the maps with information stored in computer readable storage within the control unit 200 such that the reprogrammed ethanol map comprises values optimized for regulating performance of the internal combustion engine on the alternative fuel, wherein the alternative fuel comprises one of propane, hydrogen, and natural gas. The map, before reprogramming, is exclusively referenced by the fuel control module when the vehicle is sensed by the fuel control module to be running on ethanol. In alternative embodiments, the map may be exclusively associated with one of another of type of alternative fuels.

The method 100 proceeds when an aftermarket control unit is affixed 104 to one or more of: an OBDII port of the bi-fuel vehicle, and a signal bearing medium for carrying an electronic signal from an ethanol sensor measuring fuel in the vehicle's fuel line. The fuel control module, is the shown embodiment, must have originally been configured to regulate fuel flow of one or more of gasoline and ethanol. The fuel control module (FCM) may be in unidirectional communication with the ethanol sensor, or logical communication, two way communication, with the ethanol sensor.

The method 100 proceeds when a switching mechanism is manually activated 106 on the control unit by an operator of the vehicle wishing to change the type of fuel being used to power the internal combustion engine of the vehicle. The control unit 200 relays 108 a digital signal via the control unit 200, in response to activation of the switching mechanism, to the fuel control module falsely indicating one of: the presence of ethanol in a fuel line, and that the vehicle is running on ethanol. In some embodiments, the control unit is digitally activated by an onboard computer in response to a manual operator command, or a predetermined criteria in computer readable memory being satisfied.

The activation of the control unit forces 110 the fuel control module to reference the ethanol map (or other subject map) in internal persistent computer readable memory; and subsequently forces 112 the fuel control module to regulate fuel flow of the alternative fuel to the internal combustion engine in accordance with the reprogrammed ethanol map.

The internal combustion engine in then run 114 on the alternative fuel. The internal combustion engine is run optimally on the alternative fuel using values in the subject map.

In some embodiments, the method 100 further comprising one or more of the steps of: installing 116 aftermarket fuel injectors on the vehicle for injecting the alternative fuel; temporarily disabling 118 OEM (original equipment manufacturer) sensors on OEM fuel injectors in response to the button on the control unit being depressed; and relaying electronic signals 120 on aftermarket sensors affixed to the aftermarket fuel injectors to the fuel control unit in place of electronic signals from the OEM fuel injectors. These signals may be relayed wirelessly.

The method 100 may further comprising one or more of the steps of: installing aftermarket one or more aftermarket fuel rails on the vehicle, the fuel rail comprising one or more of a fuel pressure sensor and a fuel temperature sensor; temporarily disabling one or more OEM fuel pressure sensors in response to the button on the control unit being depressed; temporarily disabling one or more OEM fuel temperature sensor(s) in response to the button on the control unit being depressed; and relaying electronic signals from sensors on the fuel rail to the fuel control unit in place of electronic signals from the OEM fuel injectors.

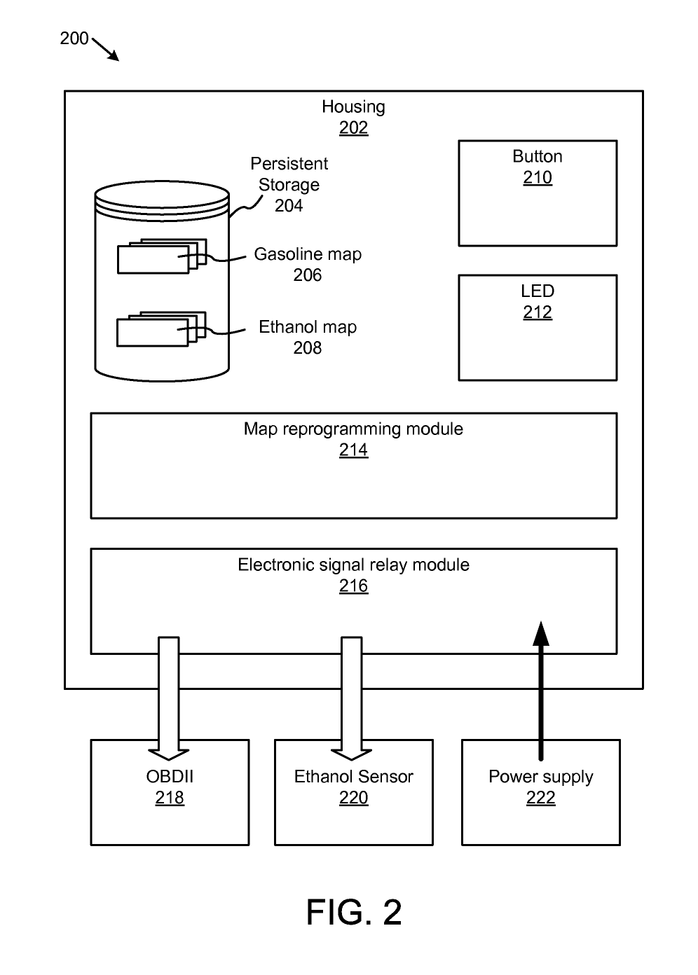

FIG. 2 is a block diagram illustrating another embodiment of control unit 200 for overriding an ethanol sensor in a vehicle in accordance with the present invention. The control unit 200 comprises a housing 202, persistent storage 204, a gasoline map 206, an ethanol map 208, a button 210, an LED 212, a map reprogramming module 214, and an electronic signal relay module 216. Also shown are an OBDII port 218, an ethanol sensor 220, and a power supply 222.

The housing 202 comprises an alloy and/or resin and/or polymer and/or wood unit defining a hollow interior. The interior consists of a hollow recess within the housing 202, in some embodiments, houses all of the components 204-216. The housing 202 may be cubic in shape, conical, cylindrical, spherical, hemispherical, or any other geometric shape with an interior volume of 0.1 liters to 5 liters.

The LED 212 is well-known to those of skill in the art. The LED 212 is activated by the control unit 200 when a false signal is sent to the fuel control module of a bi-fuel vehicle via the signal bearing medium meant to be used by OEM ethanol sensor on the vehicle.

The control unit 200, in some embodiments, receives electronic signals directly from sensors on an aftermarket fuel rail installed on the vehicle. The aftermarket sensors on the fuel rail may consist of, or comprise, a fuel temperature sensor, a fuel pressure sensor, a hydrogen sensor, and the like. Additionally, the control unit 200 may be in direct electronic contact with one or more sensors for measuring the levels of one or more combustible gases in the cabin of the bi-fuel vehicle, including combustible gas detector(s), or sensor(s), affixed to the housing which are capable of detecting elevated levels of one or more combustible gas(es) from the group consisting of natural gas, isobutene, propane, benzene, acetylene, nitrous oxide, methane, carbon monoxide, and hydrogen; wherein the gas detector(s) comprise one or more of a laser gas detector and a thermal conductivity sensor; wherein the detectors are configured to perpetually measure levels of the combustible gas(es).

Those of skill in the art recognize that the control unit 200 may be more simple or complex than illustrated so long as the control unit 200 includes modules, components or sub-systems that correspond to those described herein, or those described in the method 100. The control unit 200 may comprise a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

Typically, the control unit 200 comprises one or more central processing units executing software and/or firmware to control and manage the other components within the control unit 200. In one embodiment, the control unit 200 comprises hardware and/or software more commonly referred to as a Multiple Virtual Storage (MVS), OS/390, zSeries/Operating System (z/OS), UNIX, Linux, Android, or a Windows operating system.

The control unit 116 may communicate wirelessly with one or more of the fuel pressure sensor, the fuel temperature sensor, and/or the ethanol sensor using means known those of skill in the art. The control unit 116 may be in logical communication with the vehicle through a networked environment, such as local area network (LAN) or wide area network (WAN). Alternatively, the control unit 200 may communicate via cable directly with the fuel control module using protocols known to those of skill in the art.

In alternative embodiments, the control unit 116 communicates wirelessly with other wireless personal DPDs such as laptops, Palm Pilots®, GPS signaling devices, and the like, to download newer version of maps for optimizing fuel regulation within the vehicle.

The control unit may comprise internal memory and functional components for reprogramming, or re-flashing, one or more of the maps (or look up tables) used by the fuel control module to regulate the internal combustion engine using means known to those of skill in the art.

The persistent storage 204 provides persistent storage of data. In particular, the persistent storage 204 stores computer readable data structure look up tables comprises value exclusively associated with one type of fuel for the subject vehicle. In the shown embodiment, the persistent storage 204 is internal to the control unit 200, but may be external to the control unit 200.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A control unit for overriding an ethanol sensor in a vehicle, the control unit comprising:
a housing between 0.1 liters and 2 liters in volume;
one or more signal bearing wires for logically communicating a digital signal to a fuel control module of a vehicle, the wires configured to bypass an ethanol fuel sensor sensing ethanol passing through a fuel line of the vehicle;
a button affixed to outside of the housing;
an electronic signal relay module, housed within the housing, for relaying a digital signal to the fuel control module via the signal bearing medium used by the ethanol sensor, the digital signal overriding the ethanol sensor in response to the button on the housing being depressed, wherein the digital signal falsely indicates to the fuel control module that ethanol is being run through the fuel line.

2. The control unit of claim 1, wherein the control unit is in communication with the fuel control module, wherein the control unit is configured to replace digital readings received by the fuel control module from OEM sensors on fuel injectors, and wherein the control unit is further configured to replace said digital readings with substitute digital readings derived from one of: aftermarket sensors on one of the fuel line and the fuel injectors, and readings stored in one or more computer readable database tables in computer readable memory within the housing.

3. The control unit of claim 1, further comprising one or more LED(s) configured to activate on when the button is depressed.

4. A method for overriding sensory input to an OEM fuel control module in a vehicle such that the fuel control module of the vehicle optimally regulates fuel flow of an alternative fuel to an internal combustion engine, the steps of the method comprising:
reprogramming a look up table data structure in persistent computer readable memory accessible by the fuel control module (the “ethanol map”) such that the ethanol map comprises values optimized for regulating performance of the internal combustion engine on the alternative fuel, wherein the alternative fuel comprises one of propane, hydrogen, and natural gas; wherein the map, before reprogramming, is exclusively referenced by the fuel control module when the vehicle is sensed by the fuel control module to be running on ethanol;
affixing an aftermarket control unit to one or more of: an OBDII port of the bi-fuel vehicle, and a signal bearing medium for carrying an electronic signal from an ethanol sensor measuring fuel in the vehicle's fuel line;
wherein the fuel control module was originally configured to regulate fuel flow of one or more of gasoline and ethanol;
manually activating a switching mechanism on the control unit;
relaying a digital signal via the control unit, in response to activation of the switching mechanism, to the fuel control module falsely indicating one of: the presence of ethanol in a fuel line, and that the vehicle is running on ethanol;
forcing the fuel control module to reference the ethanol map in internal persistent computer readable memory;
forcing the fuel control module to regulate fuel flow of the alternative fuel to the internal combustion engine in accordance with the reprogrammed ethanol map; and
running the internal combustion engine on the alternative fuel.

5. The method of claim 1, further comprising one or more of the steps of:
installing aftermarket fuel injectors on the vehicle for injecting the alternative fuel;
temporarily disabling OEM sensors on OEM fuel injectors in response to the button on the control unit being depressed; and
relaying electronic signals on aftermarket sensors affixed to the aftermarket fuel injectors to the fuel control unit in place of electronic signals from the OEM fuel injectors.

6. The method of claim 1, further comprising one or more of the steps of:
installing aftermarket one or more aftermarket fuel rails on the vehicle, the fuel rail comprising one or more of a fuel pressure sensor and a fuel temperature sensor;
temporarily disabling one or more OEM fuel pressure sensors in response to the button on the control unit being depressed;
temporarily disabling one or more OEM fuel temperature sensor(s) in response to the button on the control unit being depressed; and
relaying electronic signals from sensors on the fuel rail to the fuel control unit in place of electronic signals from the OEM fuel injectors.
